(19) United States
(12) Patent Application Publication
(10) Pub. No.: US 2025/0334093 A1
(43) Pub. Date: Oct. 30, 2025

(54) EMERGENCY FUEL SHUTOFF BATTERY FOR GAS POWERED GENERATOR

(71) Applicant: RV Mobile Power LLC, Columbus, OH (US)

(72) Inventor: Stephen H. Holt, Columbus, OH (US)

(73) Assignee: RV Mobile Power LLC, Columbus, OH (US)

(21) Appl. No.: 19/192,129

(22) Filed: Apr. 28, 2025

Related U.S. Application Data
(60) Provisional application No. 63/638,803, filed on Apr. 25, 2024.

(51) Int. Cl. F02N 11/08; F02D 19/06; F02D 29/06

(52) U.S. Cl. CPC F02N 11/0862; F02D 19/0623; F02D 19/0647; F02D 19/0681; F02D 29/06

(57) ABSTRACT

Various embodiments of an emergency power assembly for a gas-powered generator are provided herein. The assembly further comprises a positive external terminal post, a negative external terminal post, a starting controls module electrically connected to the positive external terminal post and the negative external terminal post, a gas shutoff solenoid electrically connected to the starting controls module, and an emergency start plug electrically connected to the starting controls module and adapted to accept power from an emergency pull start battery and direct said power to the starting controls module which opens the gas shutoff solenoid.

### CROSS-REFERENCE TO RELATED APPLICATIONS

This application claims priority to co-pending U.S. Provisional Application No. 63/638,803 filed on Apr. 25, 2024; which is herein incorporated by reference in its entirety.

### BACKGROUND

Gas-powered engines in generators may contain various safety features to ensure that gas/fuel is not ingested for combustion when it should not be or placed on-demand for the engine in any way if combustion is not about to incur. To ensure protection against leaks there may be gas solenoids used to prevent any flow of fuel. However, these can cause problems with generators designed for electric start, which need a certain amount of power for starting, and this power may drop to where the solenoids cannot open and no emergency start can occur.

### BRIEF DESCRIPTION OF THE DRAWINGS

These drawings illustrate certain aspects of some of the embodiments of the present disclosure and should not be used to limit the scope of any embodiment.

FIG. 1 is a front perspective view of a generator equipped with one embodiment of the emergency pull start system, showing some of the basic components of one type of generator that could be used with the exemplary embodiments herein.

FIG. 2 is a simplified electrical wiring schematic showing one embodiment for the routing of battery conductors, control wires, and starting components.

FIG. 3 is a front projection view of a generator pan with one embodiment of the emergency plug installed in the pan, showing the cover removed.

FIG. 4 is a front projection view of the generator pan and plug of FIG. 3 where one embodiment of an emergency pull start battery has been connected to the plug.

FIG. 5 is a chart showing the voltage range for one embodiment of the starting battery.

FIG. 6 is a logic flowchart showing one embodiment of the logic for operating an exemplary generator with the emergency pull start system.

FIG. 7 is a top projection view of another embodiment of a generator pan having one type of emergency pull start plug.

### DETAILED DESCRIPTION

50 gas powered generator
75 generator pan
100 muffler
110 spark plug boot
120 control panel
130 oil fill cap with dipstick
140 air filter cover
150 display
160 pull start
170 gasoline pump
180 gasoline filter
190 starting controls module
200 fan
210 fuel selection switch (gasoline/LP gas)
220 LP gas shutoff solenoid
230 gasoline shutoff solenoid
240 emergency start plug
245 plug cover
250 carburetor
260 starting battery
270 frame of vehicle
280 diode
310 positive internal terminal post
320 negative internal terminal post
330 positive external terminal post
340 negative external terminal post
350 emergency pull start battery
360 gasoline primer button
370 AC output breaker
375 electrical overload reset button
380 status indicator lights
385 electric start button
390 battery cable

Disclosed herein are various embodiments of an emergency battery system for pull starting a generator 50 when a traditional starting battery 260 may be severely drained, completely dead, inoperable, or non-existent. In these situations, an emergency pull start battery can be used that can connect with an emergency start plug in order to transfer power to a pair of internal terminal posts inside the generator. A starting controls module 190 may accept power from at least one of the internal terminal posts in order to operate one or more components that may be necessary to start the generator 50. In some embodiments, the emergency pull start battery 350 may be used to power one or more fuel shutoff solenoids that would otherwise prevent fuel from being transferred into the combustion chamber. In some embodiments, the emergency pull start battery 350 may be used to power a gasoline pump 170 so that a primer button can be used or so that the gasoline will flow as soon as the manual pull start is engaged.

A diode may be used to prevent power from the emergency pull start battery from being drawn by the starting battery. The various embodiments ensure that the generator fuel system operates safely even in emergency conditions. The various embodiments also provide for situations when a starting battery is not available but the pull start alone cannot initiate combustion due to various safety features such as shutoff solenoids.

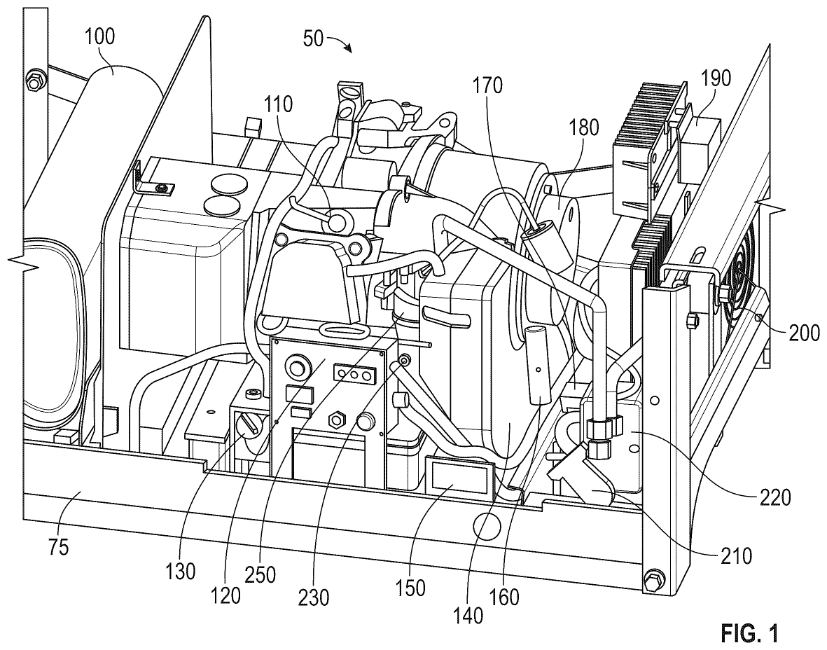

FIG. 1 is a front perspective view of a generator 50 equipped with one embodiment of the emergency pull start system, showing some of the basic components of one type of generator that could be used with the exemplary embodiments herein. An exemplary generator 50 may contain a pan 75 which provides the base for the components to be mounted to, including the emergency start plug 240 within the sidewall of the pan 75 in this embodiment (although the plug 240 could be located in other locations depending on the application). A top cover (not shown) may slide over the components and connect with the pan 75. A muffler 100 is connected to the output of the exhaust of a combustion engine with the spark plug boot 110 located at the top of the combustion engine. A control panel 120 may be placed at the front of the generator 50 and above the pan 75 for access by the user to various controls such as gasoline priming or electric start when available (control panel 120 and its functions are described further below).

An oil fill cap with dipstick 130 is typically positioned on the bottom side of the combustion engine with an air filter cover 140 also positioned adjacent to the combustion engine. An optional display 150 may be used to provide data to a user such as total running time of the generator, running time for this session, output power voltage, and output power frequency. A pull start 160 is also preferably located for easy access by the user for starting the generator 50 when the starting batteries do not have enough charge. However, as described further herein, various safety systems may be used to prevent unwanted discharge of fuel, especially when using a generator that is capable of running on multiple types of fuel and therefore requires that a switch is used to change between fuel types and also requires multiple different fuel lines ran within the generator housing or pan. Thus, in some situations the power from the pull start 160 alone may not be enough to start the generator 50, due to the requirement for enough voltage to open solenoids and run fuel pumps.

A starting controls module 190 may contain an electrical processor and electrical storage to digitally control the components and generator functions described and shown herein. The starting controls module may be in electrical communication with the control panel 120 and the various switches shown and described herein, as well as optional additional switches/modules. A gasoline pump 170 may be controlled by a combination of the starting controls module 190 as well as the controls on the control panel 120. As is traditionally used, a gasoline filter 180 may be positioned to ensure that gasoline impurities are removed prior to going through the gasoline pump or into the carburetor (if used). A fan 200 may be positioned to draw cooling air overtop various components of the generator 50 including but not limited to an inverter (if used), the gasoline pump 170, and sometimes the combustion engine.

A fuel selection switch 210 may be used to switch between different fuel types, many times this would be between gasoline and LP gas but could include other fuels such as hydrogen and natural gas. Each fuel type would preferably have some type of fuel shutoff solenoid for protection and safety, along with a switch for changing fuel types, but it will depend on each specific application. Here we will discuss a dual fuel gasoline and LP embodiment, but it should be easily recognized that additional fuels or alternate fuels could be serviced and controlled in the same manner. In this example, there is a gasoline line with a gasoline shutoff solenoid 230 which is a normally closed solenoid that only opens once it receives power (i.e. voltage strong enough to open the solenoid) from the starting control module 190. Additionally, there is an LP line with an LP shutoff solenoid 220 which is a normally closed solenoid that only opens once it receives power (i.e. voltage strong enough to open the solenoid) from the starting control module 190.

A carburetor 250 may be used depending on the application and if used it should be positioned adjacent to the combustion engine. Typically the gasoline shutoff solenoid 230 is positioned on or adjacent to the carburetor 250, preferably on the bottom side of the carburetor 250.

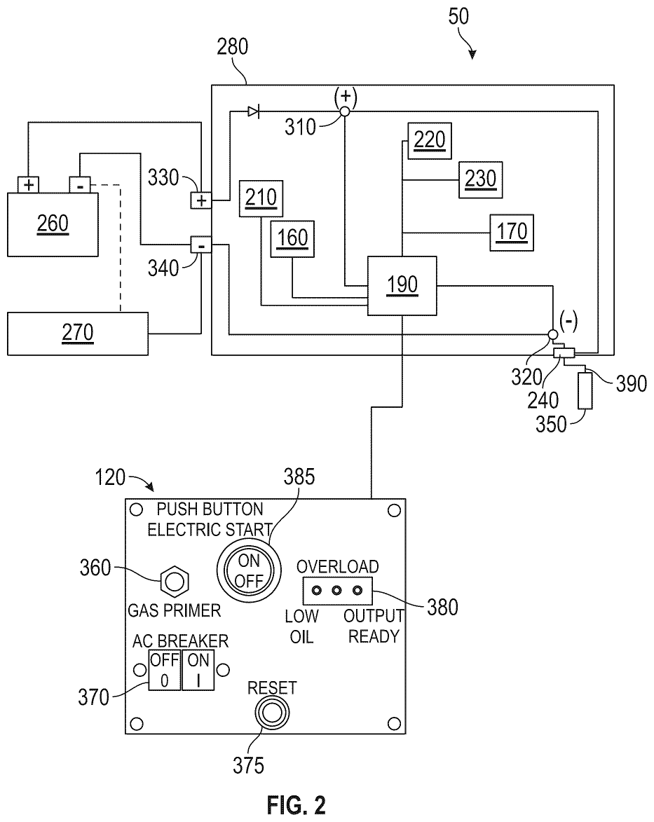

FIG. 2 is a simplified electrical wiring schematic showing one embodiment for the routing of battery conductors, control wires, and starting components. The generator 50 may include a pair of external terminal posts which may be used to connected to a starting battery 260 which under normal conditions would be used to electrically start the generator when the engine start button 385 is pushed. However, in some situations the starting battery 260 may be drained to a point where it will no longer turn over the combustion engine. Further, the starting battery 260 may even be drained to a point where it will no longer run operations on the starting controls module 190, often this is in the range of 9.0-9.5 Volts DC but can vary depending on the starting components used.

The positive conductor for the starting battery 260 may be connected to the positive external terminal post 330 while the negative conductor for the starting battery 260 may be connected to the negative external terminal post 340. In some embodiments, a second negative conductor may be used to connect the generator 50 to a vehicle frame 270 (ex. truck, Van, RV, towable trailer, and similar). Also in some embodiments, a third optional negative conductor can be connected from the negative terminal on the starting battery 260 to the vehicle frame 270.

Once inside the generator housing, a positive conductor may be used to connect the external terminal post 330 with the internal terminal post 310. Similarly, a negative conductor may be used to connect the external terminal post 340 with the internal terminal post 320. A diode 280 may be positioned as shown on the positive conductor between the external and internal posts 330 and 310 to ensure that power from the emergency manual start battery 350 is not fed back into the starting battery 260.

An emergency start plug 240 may be located on the housing of the generator 50, in some embodiments on the front side of the generator for easy access by the user. A positive conductor may be used to connect between a positive terminal on the plug 240 and the positive internal terminal post 310. Similarly, a negative conductor may be used to connect between a negative terminal on the plug 240 and the negative internal terminal post 320. The starting controls module 190 is preferably connected to both the positive and negative internal terminal posts 310 and 320 either directly or indirectly) and in this way can accept power from either the starting battery 260 or the emergency pull start battery 350, depending on the circumstances.

A control panel 120 may also be in electrical connection with the starting controls module 190 such that under normal operations, a variety of functions can be initiated by a user from the control panel 120. An electric start button 385 can be used to electrically initiate a start sequence operated by the starting controls module 190 which would automatically try to crank the combustion engine (during normal operations) in addition to operating a variety of other starting components to initiate and maintain proper combustion and power generation. A gasoline primer button 360 can be held down by a user to operate the gasoline pump 300 prior to initiating the start sequence to ensure gasoline is ready for combustion. If the generator has an electrical overload this can be reset by pressing the electrical overload reset button 375. Optionally, the generator may include one or more output breakers 370 which can be switched on or off, in addition to a number of status indicator lights 380 which can indicate a number of conditions including low oil, electrical overload, operating status, power generation, etc.

Some of the embodiments herein are designed for situations where the starting battery 260 cannot electrically start the combustion engine based on pressing the start button 385. In these situations, many times the starting battery 260 may not have enough energy (cold cranking amps) to crank the combustion engine, but may still have enough to operate the functions of the starting controls module 190 and could still start the generator 50 provided that the pull start 160 is pulled by the user. However, in some emergency situations the starting battery 260 has either been drawn down severally or simply does not exist and therefore cannot even be used to operate the functions of the starting controls module 190 even when the pull start 160 is pulled by the user. Thus, some of the embodiments herein are designed for these emergency situations so that the functions of the starting control module 190 can still operate even when the starting battery 260 is completely dead, very low, or non-existent.

In these emergency situations, an emergency pull start battery 350 may be used to send power through an emergency battery cable 390 to an emergency start plug 240, which may then transfer power to the internal terminal posts 310 and 320. The starting controls module 190 can then obtain power through these internal terminal posts 310 and 320 to operate the gasoline pump 170, LP gas shutoff solenoid 220, and the gasoline shutoff solenoid 230, as well as other starting components such as a spark ignitor, combustion fan, etc. While other starting components may be used in many of these embodiments, they have not been described herein as there functionality generally does not change whether the starting battery 260 is dead or not. Thus only the components which have unique safety features have been shown and described herein as these would otherwise prevent the generator 50 from starting even in a pull start situation.

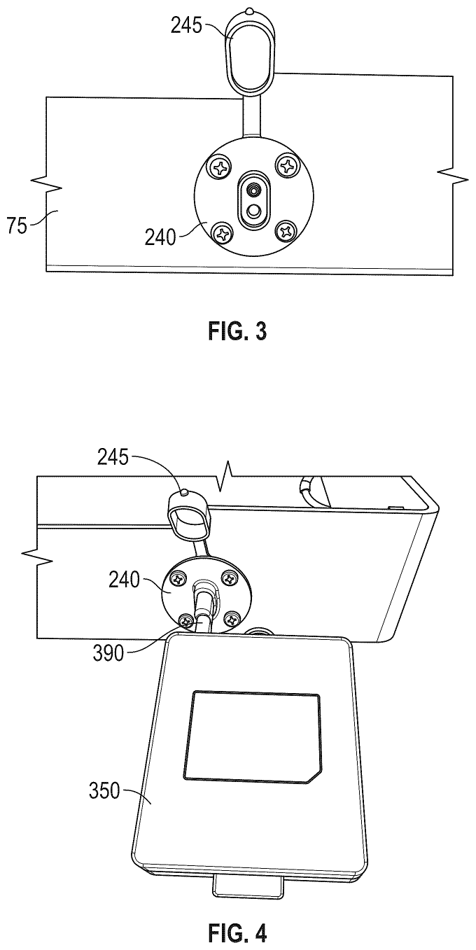

FIG. 3 is a front projection view of a generator pan 75 with one embodiment of the emergency plug 240 installed in the pan 75, showing the cover 245 removed. To prevent the intrusion of water, dust, and dirt, some embodiments may use a cover 245 which slides atop the electrical contacts of the plug 240 to prevent corrosion and ensure good conductivity throughout the life of the generator 50. In some embodiments the plug 240 is mounted directly to the pan 75 so that a cover could be removed without having to remove or unplug the plug 240.

FIG. 4 is a front projection view of the generator pan 75 and plug 240 of FIG. 3 where one embodiment of an emergency pull start battery 350 has been connected to the plug 240 using the emergency battery cable 390. The emergency pull start battery 350 is preferably compact and contains enough power to operate the functions of the starting controls module 190 but may not have enough power (CCA) to crank over the combustion engine. However, it should be noted that in some embodiments the emergency pull start battery 350 may be larger and contain enough power to crank over the combustion engine, but this is not required and may not be used. Generally, the starting battery 260 would be a battery with at least 350 CCA and 12.0V-13.0V DC. However, the emergency pull start battery 350 may be smaller, more transportable, safer, and would provide less than the amount to crank the engine (ex. 350 CCA) but still enough to operate the functions of the starting controls module 190, namely opening the LP gas shutoff solenoid 220 or opening the gasoline shutoff solenoid 230 or operating the gasoline pump 170. The voltage for the emergency pull start battery 350 may be between 12.0V-13.0V DC with amp hours in the range of 5 amp hours to 10 amp hours, but it should be recognized that these amounts can vary depending on the application. These are just examples of some acceptable parameters.

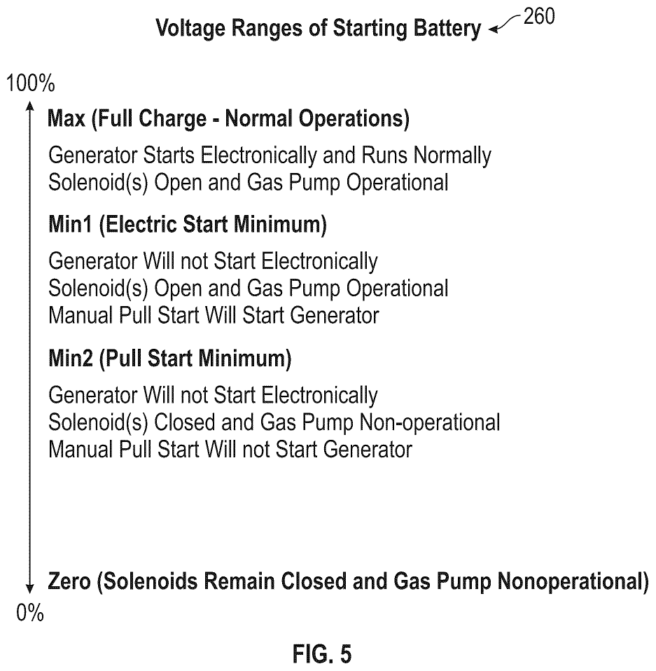

FIG. 5 is a chart showing the voltage range for one embodiment of the starting battery 260. When this embodiment of the starting battery 260 is at its maximum charge it would normally be operating under the general parameters that the generator is designed to work under. In this situation the generator can start electronically and gas solenoids 220/230 as well as gasoline pump 170 would be operational as normal. Once the incoming voltage from the starting battery 260 drops below an electric start minimum (Min1) the generator will no longer start electronically but can only be started from a manual pull start. In this condition, the generator may be directed by starting controls module 190 to open gas solenoids 220/230 as well as gasoline pump 170. The starting controls module 190 may continue to measure the incoming voltage from the starting battery 260 and once this voltage drops further below a pull start minimum (Min2) the generator will no longer start with a manual pull start because the voltage has dropped so low that there is not enough power to open gas solenoids 220/230 or operate gasoline pump 170. From this point, all the way down to 0 volts the manual pull start will not start the generator unless the emergency pull start battery 350 is used. When connected to the emergency start plug 240, the emergency pull start battery 350 can provide a solenoid and pump minimum (Min3) which may be defined as the minimum amount of power to open gas solenoids 220/230 or operate gasoline pump 170 in order to manually pull start the generator, but may not provide enough power to electrically start the generator. In situations where there is no power at all or very low power coming from the starting battery 260, the emergency pull start battery 350 can be easily connected to provide power to the starting controls module 190 so that it can open gas solenoids 220/230 or operate gasoline pump 170 while the manual pull start is being used. Otherwise, the manual pull start will not start the generator because the starting controls module 190 does not have enough incoming power (either from the starting battery 260 or the emergency pull start battery 350, or the combination) to open gas solenoids 220/230 or operate gasoline pump 170.

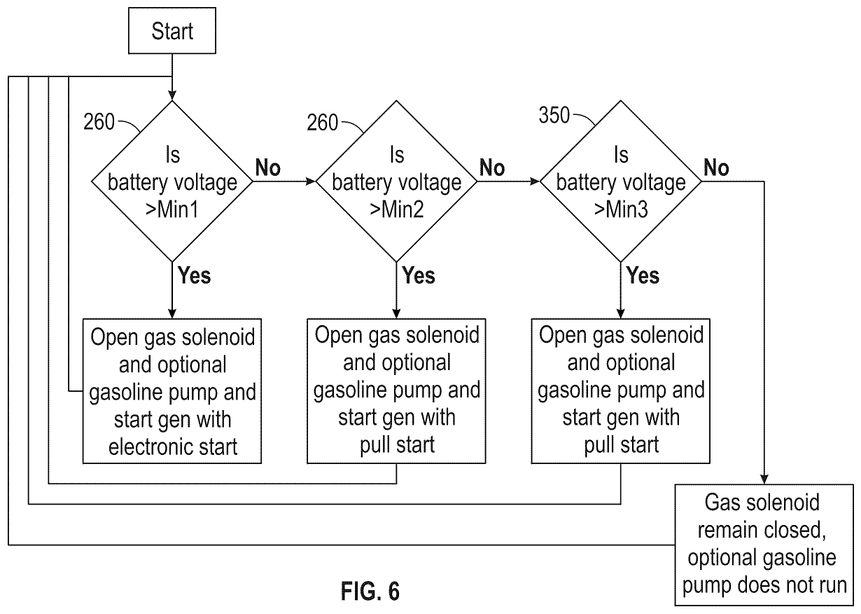

FIG. 6 is a logic flowchart showing one embodiment of the logic for operating an exemplary generator 50 with the emergency pull start system. First the system would check to see if there is a minimum operating voltage (Min1) present from the starting battery 260. If so, then the system would operate normally where the combustion engine could be electronically cranked from the start button 385. However, if the answer is no then the system may move to check the incoming voltage from the starting battery 260 and see if it is greater than a pull start minimum voltage (Min2). If the incoming voltage from the starting battery 260 is greater than Min2, then the system would no longer start the generator electronically, but can only start with a manual pull start. If the incoming voltage from the starting battery 260 is less than Min2, then the system would no longer start with a manual pull start from the starting battery 260, such that in this condition the system may then measure the incoming voltage from an emergency pull start battery 350 (using the starting controls module 190, a component therein, or a separate component) to compare it to Min3. If the incoming voltage from an emergency pull start battery 350 is greater than Min3, then the starting controls module 190 may open gas solenoids 220/230 or operate gasoline pump 170 and start the generator start with the manual pull start (but may not be started electronically).

voltage from the starting battery voltage at the internal terminal lugs 310 and 320, in many cases the system may just check the voltage at the positive terminal lug 310 as one might safely assume the voltage at the negative internal terminal lug 320 is at or near zero volts. If the voltage at the internal terminal lugs (likely positive 310 is greater than a minimum operating voltage for operating the starting components only but not crank the combustion engine (Min1) then the system would send power to the starting controls module 190 so that manual pull starting components could be operated. In this situation, when the manual pull start 160 is pulled with enough force by the user, the starting controls module 190 will begin the starting sequence which includes opening one of the fuel shutoff solenoids 220/230 depending on which fuel has been selected with the fuel selection switch 210. Only the solenoid for the selected fuel should be opened. Additionally, if the fuel selection switch 210 indicates gasoline as the desired fuel source, the primer button 360 may allow the gasoline pump 170 to energize and pump gasoline when the primer button 360 is held down by a user. Otherwise, if LP or any other fuel is selected as the desired fuel source, the primer button 360 may be inoperable.

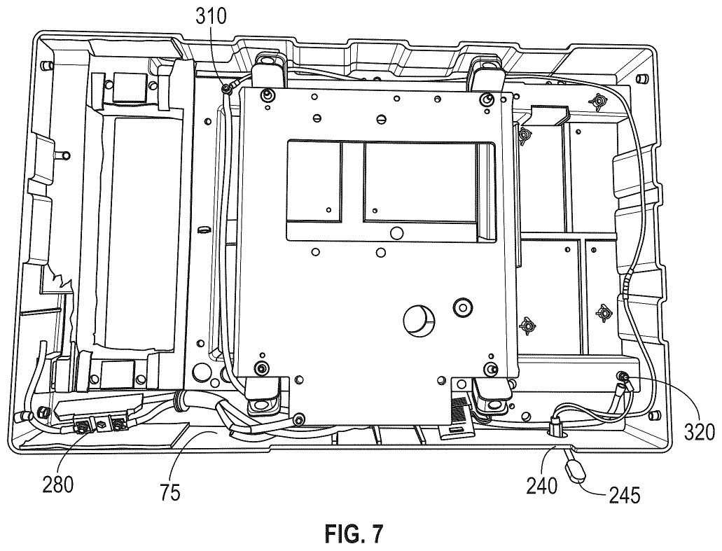

FIG. 7 is a top projection view of another embodiment of a generator pan 75 having one type of emergency pull start plug 240. A diode 280 may be positioned as shown on the positive conductor between the external and internal posts 330 and 310 to ensure that power from the emergency manual start battery 350 is not fed back into the starting battery 260.

An emergency start plug 240 may be located on the pan 75 of the generator 50, in some embodiments on the front side of the generator for easy access by the user. A positive conductor may be used to connect between a positive terminal on the plug 240 and the positive internal terminal post 310. Similarly, a negative conductor may be used to connect between a negative terminal on the plug 240 and the negative internal terminal post 320. The starting controls module 190 is preferably connected to both the positive and negative internal terminal posts 310 and 320 either directly or indirectly) and in this way can accept power from either the starting battery 260 or the emergency pull start battery 350, depending on the circumstances.

The emergency pull start battery 350 may include a number of ports for outgoing and ingoing power. For charging, the battery 350 may contain a USB type port for charging with a USB or other types of ports for accepting power from 120V AC (stepped down or converted in any manner). For discharging, the battery 350 preferably contains an output port for transferring power to the plug 240. Also, the battery 350 may contain output port(s) so that small devices such as cellular devices could be charged from the battery 350 and these ports could be USB ports for easy charging of USB devices.

As used herein, the term ‘electrically connected’ represents two components which have some sharing of electrons between them through a conductor, but this not does require a direct connection between the two components or that they share electrons directly between them with no components in between.

As used herein, the term ‘gas’ represents any combustible fuel including but not limited to gasoline, LP gas, natural gas, and hydrogen gas.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

I claim:

1. An emergency power assembly for a gas-powered generator comprising:
a positive external terminal post;
a negative external terminal post;
a starting controls module electrically connected to the positive external terminal post and the negative external terminal post;
a gas shutoff solenoid electrically connected to the starting controls module; and
an emergency start plug electrically connected to the starting controls module and adapted to accept power from an emergency pull start battery and direct said power to the starting controls module which opens the gas shutoff solenoid.

2. The assembly of claim 1 further comprising:
a gasoline pump electrically connected to the starting controls module; and
wherein the starting controls module is further adapted to accept power from an emergency pull start battery and direct said power to the gasoline pump.

3. The assembly of claim 1 further comprising:
a generator pan; and
wherein the emergency start plug is positioned on the generator pan.

4. The assembly of claim 1 further comprising:
a fuel selection switch;
an LP gas shutoff solenoid; and
wherein the starting controls module is further adapted to accept power from an emergency pull start battery and direct said power to the LP gas shutoff solenoid during a manual pull start only when the fuel selection switch indicates LP gas.

5. The assembly of claim 1 further comprising:
a positive internal terminal post electrically connected to the positive external terminal post and the emergency start plug; and
a negative internal terminal post electrically connected to the negative external terminal post and the emergency start plug.

6. The assembly of claim 5 further comprising:
a diode placed on the electrical connection between the positive external terminal post and the positive internal terminal post.

7. The assembly of claim 1 wherein:
the emergency pull start battery provides enough power to open gas shutoff solenoid but not enough power to electrically start the generator.

8. The assembly of claim 2 wherein:
the emergency pull start battery provides enough power to open gas shutoff solenoid and run the gasoline pump for a manual pull start only.

9. An emergency power assembly for a gas-powered generator comprising:
a positive external terminal post;
a negative external terminal post;
a positive internal terminal post electrically connected to the positive external terminal post;
a negative internal terminal post electrically connected to the negative external terminal post;
a starting controls module electrically connected to the positive internal terminal post and the negative internal terminal post;
an emergency start plug electrically connected to a positive internal terminal post and a negative internal terminal post; and
a diode placed on the electrical connection between the positive external terminal post and the positive internal terminal post.

10. The assembly of claim 9 further comprising:
a gas shutoff solenoid electrically connected to the starting controls module; and
a gasoline pump electrically connected to the starting controls module.

11. The assembly of claim 9 further comprising:
a generator pan; and
wherein the emergency start plug is positioned on the generator pan.

12. The assembly of claim 10 wherein:
the emergency pull start battery provides enough power to open the gas shutoff solenoid and run the gasoline pump when a voltage across the positive external terminal post and negative external terminal post is too low to electrically start the generator.

13. The assembly of claim 10 wherein:
the emergency pull start battery provides enough power to open the gas shutoff solenoid when a starting battery cannot electrically start the generator.

14. The assembly of claim 9 further comprising:
a fuel selection switch;
an LP gas shutoff solenoid; and
wherein the starting controls module is further adapted to accept power from an emergency pull start battery and direct said power to the LP gas shutoff solenoid during a manual pull start only when the fuel selection switch indicates LP gas.

15. The assembly of claim 10 wherein:
when a voltage across the positive external terminal post and negative external terminal post drops below a pull start minimum (Min2), the gas shutoff solenoid is closed and the gasoline pump is inoperable unless an emergency pull start battery is connected to the emergency start plug.

16. A method for operating an emergency power assembly for a gas-powered generator comprising:
measuring an incoming voltage from a starting battery;
starting the generator electronically and opening a gas solenoid if the incoming voltage from the starting battery is greater than an electric start minimum (Min1);
starting the generator with pull start only and opening a gas solenoid if the incoming voltage from the starting battery is greater than a pull start minimum (Min2);
measuring an incoming voltage from an emergency pull start battery if the incoming voltage from the starting battery is less than Min2;
starting the generator with pull start only and opening a gas solenoid if the incoming voltage from the emergency pull start battery is less Min2 and greater than a solenoid minimum (Min3); and
holding the gas solenoid closed if the incoming voltage from the emergency pull start battery is less than Min3.

17. The method of claim 16 further comprising:
accepting a fuel selection from a fuel selection switch; and
opening an LP gas solenoid if the fuel selection switch indicates LP gas and the incoming voltage from the emergency pull start battery is greater than Min3.

18. The method of claim 16 further comprising:
starting the generator with pull start only and running a gasoline pump if the incoming voltage from the emergency pull start battery is greater than Min3 while the incoming voltage from the starting battery is less than Min2.

19. The method of claim 16 further comprising:
running a gasoline pump while opening a gas solenoid for a pull start only if the incoming voltage from the starting battery is greater than Min2.

20. The method of claim 16 further comprising:
running a gasoline pump while opening a gas solenoid for an electric start only if the incoming voltage from the starting battery is greater than Min1.
